(19) United States
(12) Patent Application Publication
(10) Pub. No.: US 2026/0058804 A1
(43) Pub. Date: Feb. 26, 2026

(54) Multi-Laser-Driven Encryption System that Utilizes Parallel Laser Arrays Generating Simultaneously Different Light Waves to Generate Multiple Light Waves Interceptions to Create an Encryption System based on Light Waves Intersections for Quantum Computers and Where Each Laser Array is Programmed with a Morse Code-Type System to Increase the Complexity of the Encryption by Utilizing a Programmed Missing Light Waves Interception Encryption Structure as an Additional Layer of Security.

(71) Applicant: Joseph Carlo Pastrana, Sneads Ferry, NC (US)

(72) Inventor: Joseph Carlo Pastrana, Sneads Ferry, NC (US)

(21) Appl. No.: 19/368,449

(22) Filed: Oct. 24, 2025

Related U.S. Application Data
(60) Provisional application No. 63/869,280, filed on Aug. 23, 2025.

(51) Int. Cl. H04L 9/08

(52) U.S. Cl. CPC H04L 9/0852

(57) ABSTRACT

A multi laser-driven encryption system that utilizes parallel laser arrays generating simultaneously different light waves to generate multiple light waves interceptions to create an encryption system based on light waves intersections for quantum computers and computer systems and where each laser array is programmed with a Morse-Type System to increase the complexity of the encryption by utilizing programmed missing light waves interceptions as an additional layer of encryption.

### CROSS-REFERENCE TO RELATED APPLICATIONS

Not applicable to this application

### FEDERALLY SPONSORED RESEARCH OR DEVELOPMENT

Not applicable to this application

### SEQUENCE LISTING, A TABLE, OR A COMPUTER PROGRAM LISTING

Not applicable to this application

### COMPACT DISK APPENDIX

Not applicable to this application

### STATEMENT REGARDING PRIOR DISCLOSURES BY THE INVENTOR

Not applicable to this application

### BACKGROUND OF THE INVENTION

The technical field of the invention relates to the security of data processed by quantum computers and computer systems. More particularly, the present invention relates to the field of data encryption, and how data is managed and stored securely in computer systems. To improve data security, the method utilizes different light wave lengths that are created simultaneously by a multi-laser array system to generate multiple light waves interceptions to create an encryption system based on the said light waves intersections, and where each laser array is programmed with a Morse Code-Type System to increase the complexity of the encryption by utilizing programmed missing light wave interceptions as an additional encryption system for an additional layer of security. Accordingly, increasing the complexity of encryptions to protect data is highly desirable for computer systems.

### DESCRIPTION OF PRIOR ART

Not applicable to this application

### BRIEF SUMMARY OF THE INVENTION

A multi-laser-driven encryption system that utilizes parallel laser arrays generating simultaneously different light waves to generate multiple light waves interceptions to create an encryption system based on light waves intersections for quantum computer and computer systems and where each laser array is programmed with a Morse-Type System to increase the complexity of the encryption by utilizing a programmed missing light wave interceptions encryption structure as an additional layer of encryption and security.

### BRIEF DESCRIPTION OF THE SEVERAL VIEWS OF THE DRAWINGS

N/A.

### DETAILED DESCRIPTION OF THE INVENTION

A multi laser-driven encryption system that utilizes parallel laser arrays generating simultaneously different light waves to generate multiple light waves interceptions to create an encryption system based on light waves intersections for quantum computer and where each laser array is programmed with a Morse-Type System to increase the complexity of the encryption by utilizing a programmed missing light waves interceptions encryption structure as an additional layer of encryption.

A multi laser-driven encryption system comprised of laser arrays and diverse light waves, with each array generating simultaneously different light waves.

A multi laser-driven encryption system comprised of laser arrays and diverse light waves, wherein each array generates varying frequencies, polarizations, and spatial modes.

A multi laser-driven encryption system to create light waves interceptions from laser arrays at specific points, creating a unique pattern of interference to form the basis of the encryption system.

A multi laser-driven encryption system comprised of a Morse code-like system programmed for each laser array, wherein the presence or absence of specific light waves at certain times or locations within the interception pattern signifies a dot or a dash.

A multi laser-driven encryption system wherein missing interceptions are programmed to deliberate miss light waves interceptions within a pattern to create an encryption system to increase the complexity of decryption.

I claim:

1. A multi laser-driven encryption system that utilizes parallel laser arrays generating simultaneously different light waves to generate multiple light waves interceptions to create an encryption system based on light waves intersections for quantum computer and computer systems wherein each laser array is programmed with a Morse-Type System wherein at certain times or locations within the interception pattern signifies a dot or a dash to create encryptions by utilizing a programmed missing light waves interceptions encryption structure for quantum computers and computer systems

2. A method comprised of laser arrays and diverse light waves, with each array generating simultaneously different light waves and where each array generates varying frequencies, polarizations, and spatial modes to create encryptions for quantum computers and computer systems.

3. A multi laser-driven encryption system to create light waves interceptions from laser arrays at specific points, wherein each array generates varying frequencies, polarizations, and spatial modes to create a unique pattern of interference to form the basis of the encryption system for quantum computers and computer systems.
